(19) United States
(12) Patent Application Publication
(10) Pub. No.: US 2012/0005497 A1
(43) Pub. Date: Jan. 5, 2012

(54) Terminal apparatus updating method, data writing apparatus, and terminal apparatus

(75) Inventors: Sotaro Tsukamoto, Aichi (JP); Atsuhiro Harada, Gifu (JP); Makoto Ueda, Gifu (JP)

(73) Assignee: Sony Corporation, Tokyo (JP)

(21) Appl. No.: 13/064,751

(22) Filed: Apr. 13, 2011

(30) Foreign Application Priority Data
Jun. 30, 2010 (JP) 2010-150176

(51) Int. Cl. G06F 9/44; G06F 1/26

(52) U.S. Cl. 713/310; 717/172

(57) ABSTRACT

A terminal apparatus updating method is disclosed which includes: performing a wireless power supply process of wirelessly supplying power to a terminal apparatus equipped with a wireless power reception portion so as to start up the terminal apparatus thus powered; performing a wireless transmission process of wirelessly transmitting firmware write data to the terminal apparatus started up in the wireless power supply process using a suitable wireless communication function; performing a write process of causing the terminal apparatus having received the firmware write data in the wireless transmission process to write the firmware write data to a storage portion inside the terminal apparatus; and stopping the wireless power supply process upon determination that the write process is completed.

### BACKGROUND OF THE INVENTION

1. Field of the Invention

The present invention relates generally to a terminal apparatus updating method, a data writing apparatus for executing that terminal apparatus updating method, and a terminal apparatus to which data is written by that data writing apparatus. More particularly, the invention relates to technology to which wireless power supply processing is applied.

2. Description of the Related Art

Heretofore, various terminal apparatuses in the form of electronic devices such as mobile phones have often had their internal firmware updated upon shipment from the factory or the like. That is, the firmware in such terminal apparatuses is sometimes updated successively after they have been marketed. To perform such updates involves update work that rewrites the firmware in the terminal apparatuses upon shipment with its most recent version.

Ordinary update work involves connecting a data communication terminal of the terminal apparatus to a firmware update work device typically upon shipment from the factory, and getting the work device to transfer the latest firmware to the terminal apparatus so as to have the latter rewrite its firmware inside. When this kind of update work is to be carried out, the terminal apparatus is operated with its power supply input terminal being fed with power either from the work device or from a separate power source. Usually, terminal apparatuses such as mobile phones are not furnished with their battery packs upon shipment and thus may not have their firmware updated or get any other process executed without being powered externally.

Where such update work is not performed upon shipment from the factory, dealers marketing terminal apparatuses are to update the firmware upon sale or users are to connect their terminal apparatuses to a firmware updating website via the Internet or the like in order to update the firmware.

Japanese Patent Laid-Open No. 2010-114813 (called Patent Document 1 hereunder) discloses an example in which the firmware of a mobile phone is updated wirelessly.

### SUMMARY OF THE INVENTION

The above-mentioned update of firmware should preferably be done upon shipment of each terminal apparatus as a product. When the firmware is updated upon shipment, the shipped terminal apparatuses are supposed to carry the latest version of the firmware at least at the time of shipment and prior to being marketed.

However, the workability of such updates is very poor: it is quite troublesome to connect each and every terminal apparatus individually to the update work device for update work upon shipment from the factory or warehouse. Usually, each terminal apparatus manufactured in the factory and packaged for shipment is housed individually in a box for sale. The box is to be opened and the terminal apparatus is to be unpacked and taken out from inside and connected to the work device using a connector. Once update work is done, the terminal apparatus is to be put back into the box. The more terminal apparatuses that are subject to update work, the more time and effort it will take to perform their update. Furthermore, plugging and unplugging the connector can inadvertently damage the terminal apparatus or scratch its enclosure, which is obviously undesirable.

If the terminal apparatus itself is equipped with a wireless communication capability, then its firmware can be updated using a wireless communication scheme as discussed in Patent Document 1 for example. It would be desirable if a firmware updating process could be carried out wirelessly upon shipment from the factory or the like. However, this may not be done in practice. When electronic devices such as mobile phone terminal apparatuses are shipped, they are generally packaged without their battery packs. That means the terminal apparatuses remain switched off as packaged and may not initiate wireless communication as such. It follows that in order to update the firmware of the terminal apparatuses prior to their shipment, the apparatuses are usually unpacked, connected to the update work device via a communication terminal or the like, and powered externally to have necessary data transferred thereto for update.

The present invention has been made in view of the above circumstances and provides arrangements for improving workability in updating the firmware of products such as terminal apparatuses.

According to one embodiment thereof, there is provided a terminal apparatus updating method of writing firmware to a terminal apparatus equipped with a wireless power reception portion. The method includes performing a wireless power supply process of wirelessly supplying power to the terminal apparatus having the wireless power reception portion so as to start up the terminal apparatus thus powered. Firmware write data is wirelessly transmitted to the terminal apparatus started up in the wireless power supply process, using a suitable wireless communication function. The terminal apparatus is caused to write the wirelessly transmitted firmware write data to a storage portion inside the terminal apparatus. Upon completion of the writing process, the terminal apparatus is caused to notify a writing apparatus thereof. The wireless supply of power is stopped upon determination that the writing process is completed.

In the manner outlined above, the terminal apparatus is started up with its power wirelessly supplied from an external source. When thus started up, the terminal apparatus has the firmware write data written thereinto. It follows that the firmware of the terminal apparatus can be updated with no battery attached thereto and with no connector or other object plugged into any terminal of the terminal apparatus.

According to another embodiment thereof, there is provided a data writing apparatus including a control portion configured to supply power wirelessly to a terminal apparatus equipped with a wireless power reception portion so as to start up the terminal apparatus thus powered; to transmit firmware write data wirelessly to the terminal apparatus started up when wirelessly supplied with power using a suitable wireless communication function so that the firmware write data is written to the terminal apparatus; and to stop the wireless power supply following the writing of the firmware write data.

According to a further embodiment thereof, there is provided a terminal apparatus including a control portion configured to start up the terminal apparatus upon detecting reception of power in a wireless power reception process and, upon receiving firmware write data in the start-up state using a suitable wireless communication function, to perform a control process of writing the received firmware write data to a storage portion of the terminal apparatus.

According to this invention, the firmware of the terminal apparatus can be updated without making any physical contact therewith. For example, terminal apparatuses may have their firmware updated while they are being packed in boxes upon shipment from the factory. The firmware of each terminal apparatus can thus be updated easily to the latest version when shipped from the factory or warehouse for example, with appreciably less time and effort being taken.

### BRIEF DESCRIPTION OF THE DRAWINGS

FIG. 1 is a schematic view explanatory of a typical overall configuration of an embodiment of the present invention;

FIG. 2 is a schematic view explanatory of a typical overall configuration of an embodiment of the invention in which a sealed case is not used;

FIG. 3 is a block diagram showing a typical structure of a terminal apparatus as an embodiment of the invention;

FIG. 4 is a block diagram showing a typical structure of a firmware writing apparatus as an embodiment of the invention;

FIGS. 5A and 5B are schematic views explanatory of how power is supplied wirelessly by an embodiment of the invention;

FIG. 6 is a graphic representation showing how characteristics are varied depending on the orientation of an antenna according to an embodiment of the invention;

FIGS. 7A, 7B, 7C and 7D are schematic views explanatory of a typical firmware updating process performed by an embodiment of the invention;

FIG. 8 is an operation sequence diagram showing a typical firmware updating process performed by an embodiment of the invention;

FIG. 9 is a flowchart showing a typical terminal apparatus management process performed by an embodiment of the invention;

FIG. 10 is a flowchart showing a typical process of a terminal apparatus as a variation of the invention;

FIG. 11 is a flowchart showing a typical process of a terminal apparatus as another variation of the invention; and

FIG. 12 is a flowchart showing a typical process of a terminal apparatus as another variation of the invention.

### DETAILED DESCRIPTION OF THE PREFERRED EMBODIMENTS

Some preferred embodiments of the present invention will now be described under the following headings:

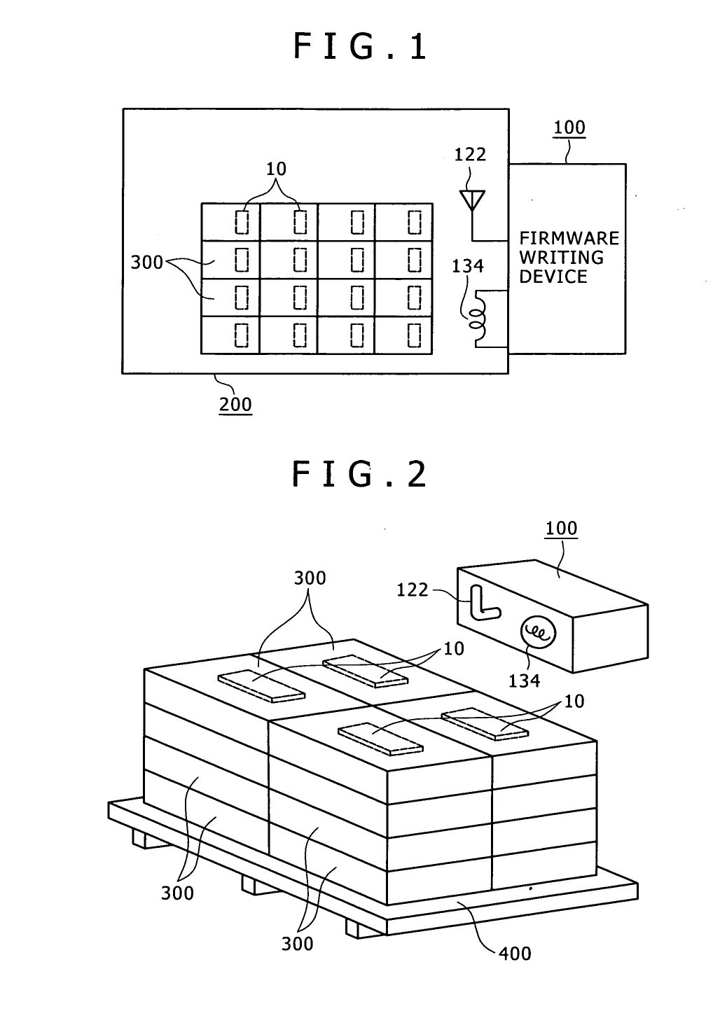

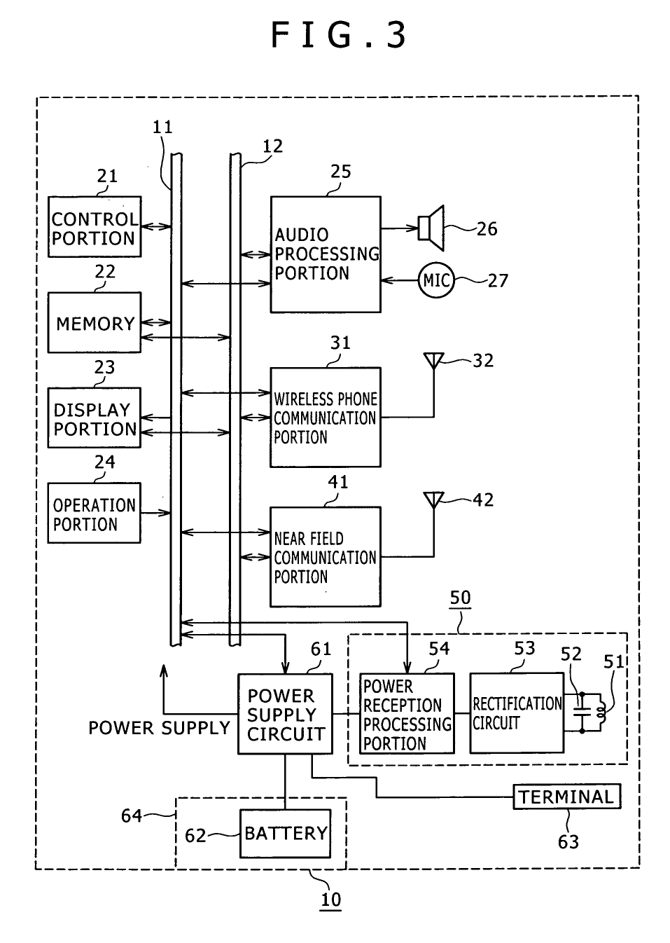

1. Typical overall configurations of an embodiment of the invention (with reference to FIGS. 1 and 2);

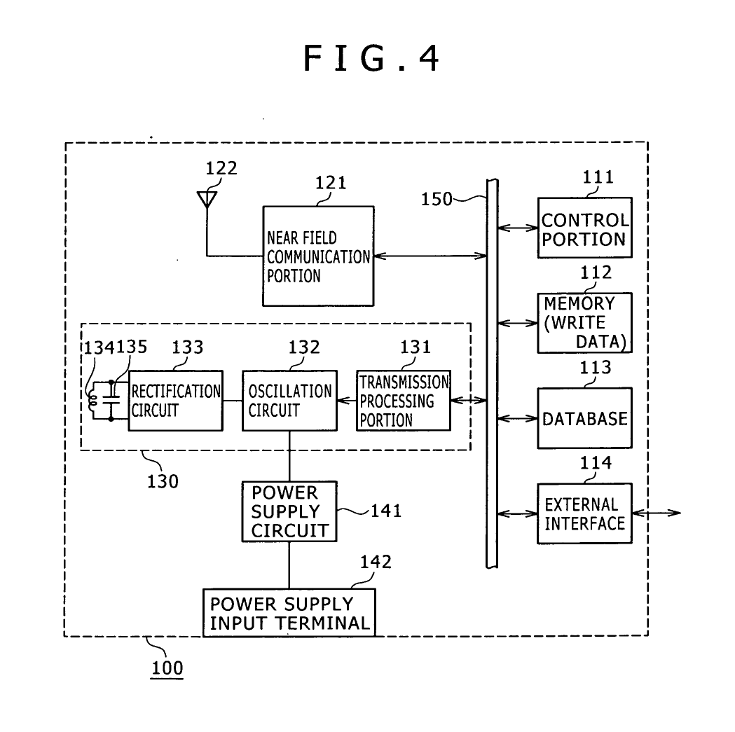

2. Typical structure of the terminal apparatus as an embodiment of the invention (with reference to FIG. 3);

3. Typical structure of the firmware writing apparatus as an embodiment of the invention (with reference to FIG. 4);

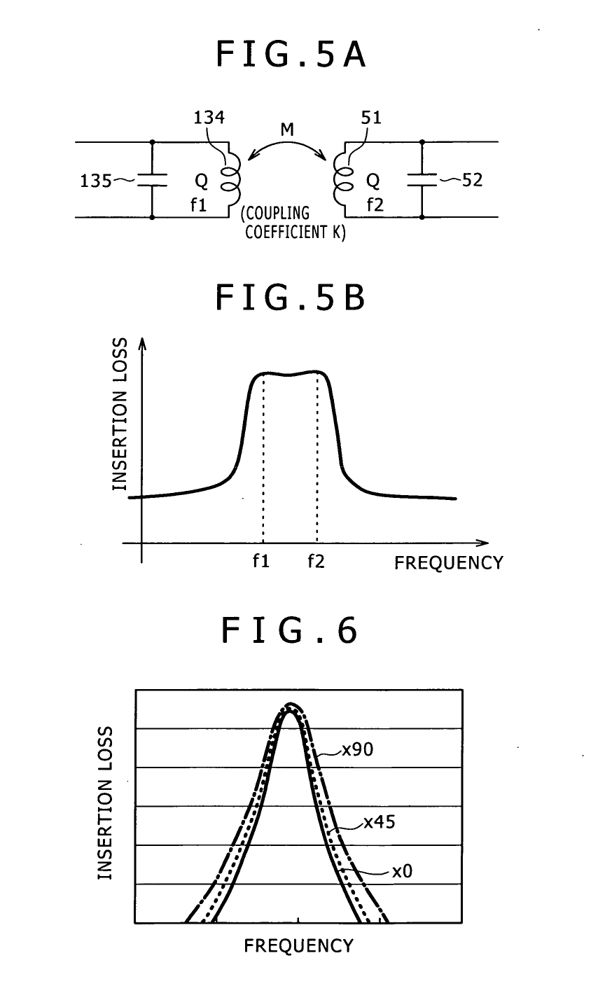

4. Explanation of wireless power supply and wireless communication applied to an embodiment of the invention (with reference to FIGS. 5A, 5B and 6);

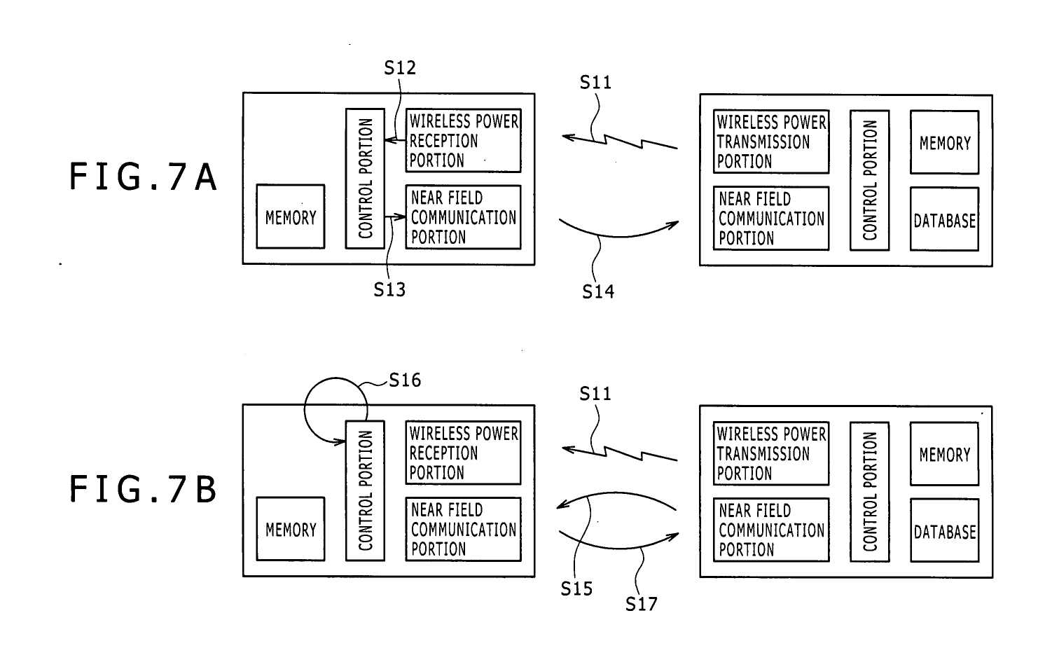

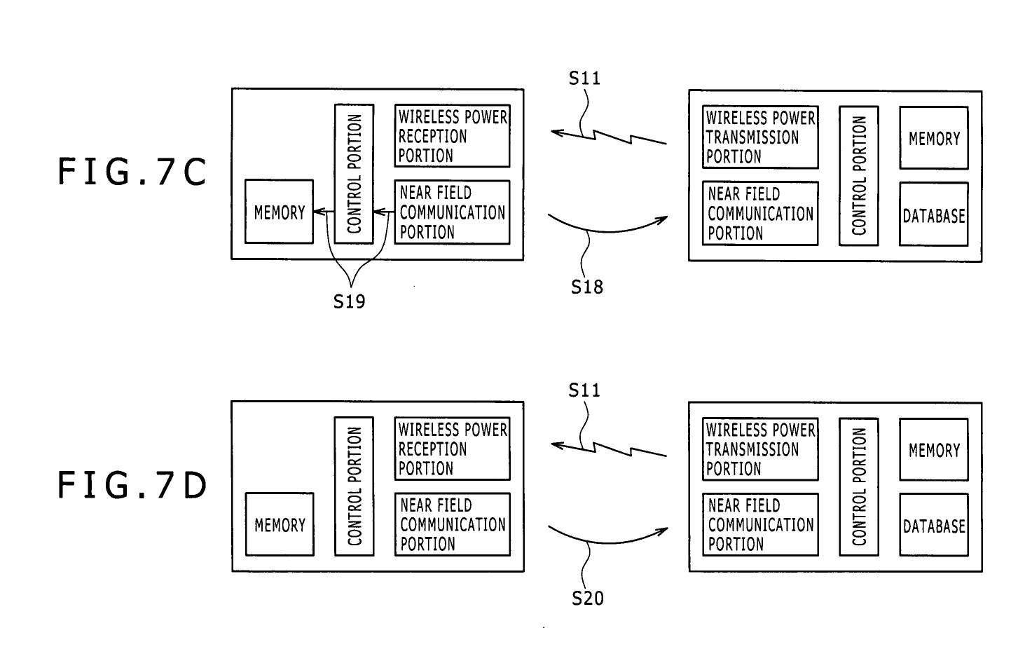

5. Explanation of the firmware updating process performed by an embodiment of the invention (with reference to FIGS. 7A through 7D, 8 and 9); and

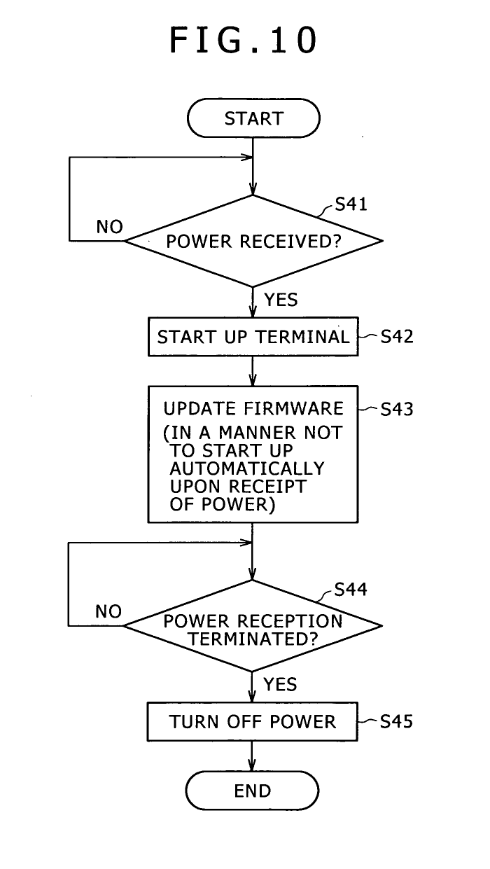

6. Variations of embodiments (with reference to FIGS. 10, 11 and 12).

### 1. Typical Overall Configurations of an Embodiment of the Invention

Explained first in reference to FIGS. 1 and 2 are typical overall configurations of a system as an embodiment of the present invention.

This embodiment is a system which, upon shipment of terminal apparatuses from the factory or warehouse for example, updates the firmware of the terminal apparatuses about to be shipped.

As shown in FIG. 1, a firmware writing apparatus 100 is provided and connected to a sealed box 200. The sealed box 200 is composed of a suitable metal or the like in a manner keeping electromagnetic waves from getting out of the box. Placed inside the sealed box 200 is a terminal apparatus 10 of which the firmware is targeted to be updated. In the example of FIG. 1, there are numerous terminal apparatuses 10 each packed in a box 300 inside the sealed box 200. The box 300 may be of any type and shape for packaging or transport purposes.

The firmware writing apparatus 100 is furnished with an antenna 122 designed for wireless communication with the terminal apparatuses 10 housed in the sealed box 200. The firmware writing apparatus 100 is also furnished with a coil antenna 134 of a wireless power transmission portion 130. A structure in which the antenna 122 and coil antenna 134 are connected will be discussed later.

With a large number of terminal apparatuses 10 housed inside the sealed box 200 as shown in FIG. 1, the firmware writing apparatus 100 is used to perform a firmware updating process.

The example in FIG. 1 utilizes the sealed box 200. Alternatively, there may be provided a configuration in which the sealed box is not used.

That is, as shown in FIG. 2, there may be a plurality of boxes 300 stacked on a transport pallet 400, each box 300 containing a terminal apparatus 10. In that case, the firmware updating process is performed on the terminal apparatuses 10 in the boxes 300 placed on the transport pallet 400. As indicated in FIG. 2, the transport pallet 400 is positioned near the firmware writing apparatus 100 so that the firmware of the terminal apparatus 10 in each of the boxes 300 on the pallet 400 may be updated. The firmware writing apparatus 100 performs the process on the terminal apparatuses 10 using the wireless communication antenna 122 and the coil antenna 134 of the wireless power transmission portion 130.

In the examples of FIGS. 1 and 2, the components of the firmware writing apparatus 100 are shown housed in a single enclosure. Alternatively, the antenna 122 for wireless communication and the coil antenna 134 for wireless power transmission may be set up inside the sealed box 20 or close to the transport pallet 400, with the firmware writing apparatus 100 proper installed in a remote location.

### 2. Typical Structure of the Terminal Apparatus as an Embodiment of the Invention

A typical structure of the terminal apparatus 10 whose firmware is to be updated is explained below in reference to FIG. 3.

In this embodiment, the terminal apparatus 10 constitutes a wireless communication terminal apparatus that is a so-called mobile phone terminal.

In the structure shown in FIG. 3, the terminal apparatus 10 includes a wireless phone communication portion 31 connected with an antenna 32. The wireless phone communication portion 31 conducts wireless communication with mobile phone base stations or the like.

During verbal communication, audio data included in the data received by the wireless phone communication portion 31 is forwarded to an audio processing portion 25. In turn, the audio processing portion 25 decodes the audio data to obtain an analog audio signal. The audio signal thus acquired is fed to a speaker 26 for output.

An audio signal picked up by a microphone 27 is also supplied to the audio processing portion 25 to be encoded thereby into suitable audio data. The audio data thus obtained is fed to the wireless phone communication portion 31 for wireless transmission.

Various processing sections such as the wireless phone communication portion 31 and audio processing portion 25 are arranged to exchange control data with a control portion 21 or the like via a control line 11. Diverse kinds of data are also transmitted via a data line 12.

On receiving e-mail data or website data, the wireless phone communication portion 31 temporarily stores the received data into a memory 22 under control of the control portion 21. The wireless phone communication portion 31 then performs processes on the data such as display on a display portion 23.

Under control of the control portion 21, the display portion 23 provides outgoing and incoming call indications necessary for the terminal apparatus as a mobile phone, display of e-mails and websites, and various other kinds of display using built-in functions. The memory 22 serving as a storage portion stores, among others, the firmware that is a program necessary for operating the terminal apparatus 10.

The firmware preinstalled in the memory 22 of the terminal apparatus 10 of this embodiment is designed to let the terminal apparatus 10 function as a mobile phone. Also prepared is firmware that starts up the terminal apparatus 10 if power is received by its wireless power reception portion 50, to be discussed later, while the terminal apparatus 10 remains switched off.

Part or all of the firmware may be updated. The firmware may be updated not only by the firmware writing apparatus 100 but also by the wireless phone communication portion 31 receiving firmware update data while the terminal apparatus 10 is being used. It is also possible to update the firmware by having the firmware update data input to the terminal apparatus 10 through a data terminal, not shown. The memory 22 accommodates data such as a serial number for identifying the terminal apparatus 10.

The terminal apparatus 10 is further provided with a near field communication portion 41 which, using an antenna 42 connected thereto, conducts short-distance wireless communication with another terminal apparatus or the like. For example, the terminal apparatus 10 may utilize a near field communication method known as TransferJet (registered trademark) that permits data transmission at speeds of as high as 560 Mbps using a 4-GHz band frequency. The TransferJet method is a technique that provides high-speed data transmission over a short communicable distance limited to a few centimeters. Wireless communication is conducted with the opposite communicating party without making preliminary connection settings. As will be discussed later, the communicable distance for wireless transmission by the near field communication portion 41 can be increased. With this embodiment, wireless communication is conducted with the firmware writing apparatus 100 over the distance of about one meter.

The near field communication portion 41 operating on the TransferJet principle permits high-speed data transmission between this terminal apparatus 10 and another terminal apparatus. For example, a relatively large amount of content data such as video data or audio data can be transferred. With this embodiment, the firmware write data is received from the firmware writing apparatus 100 through near field communication using the near field communication portion 41 operating on the TransferJet principle. The process of receiving the firmware write data will be described later.

The TransferJet method is only one example of the short-distance communication principle. Other methods can be utilized instead. For example, wireless communication methods applied to wireless LANs (local area networks) or the Bluetooth (registered trademark) method may be adopted. Still, the TransferJet method is preferred for use as the wireless transmission scheme for the update of firmware with this embodiment.

The terminal apparatus 10 uses a battery 62 attached to a battery attaching portion 64 as its power supply. A power supply circuit 41 supplies source voltages to the components of the terminal apparatus 10. For example, the battery 62 may be a lithium ion battery or some other secondary battery that can be recharged. The battery 62 is attached removably to the battery attaching portion 64. The battery 62 remains attached while the terminal apparatus 10 is being used, whereas the battery 62 is detached typically upon sale of the terminal apparatus 10. The battery 62 is recharged when placed on, say, a recharging cradle (not shown) or the like plugged typically into an outlet.

Also, the terminal apparatus 10 of this embodiment is furnished with a wireless power reception portion 50. When power is received by a coil antenna 51 of the wireless power reception portion 50, a power reception processing portion 53 of the terminal apparatus 10 acquires a constant-voltage power supply from the received power and recharges the battery 62 therewith. At the same time, the power reception processing portion 53 allows the terminal apparatus 10 to operate given the received power.

The wireless power reception portion 50 is provided with the coil antenna 51 in which a capacitor 52 is connected in parallel. The coil antenna 51 is designed to receive power transmitted from the wireless power transmission portion of a nearby apparatus. In the case of this embodiment, noncontact power reception by the wireless power reception portion 50 is accomplished using the magnetic resonance method. According to the magnetic resonance method, the resonant frequency of the power transmitting side and the resonant frequency of the power receiving side need to be set to suitably corresponding frequencies. The resonant frequencies are established by the coil antenna 51 and capacitor 52. Wireless power transmission based on the magnetic resonance principle will be discussed later in detail.

### 3. Typical Structure of the Firmware Writing Apparatus as an Embodiment of the Invention

Explained below in reference to FIG. 4 is a typical structure of the firmware writing apparatus 100.

In the firmware writing apparatus 100, a control portion 111 is connected to a memory 112 and a database 113 via a bus line 150. The memory 112 serving as a storage portion stores firmware write data. The database. 113 is structured to manage the terminal apparatuses to which firmware was written by the firmware writing apparatus 100. Alternatively, the storage portion may be structured to include the database 113. That is, part of the storage capacity of the memory 112 may be appropriated to constitute the database 113.

An external interface 114 is provided. Data may be stored into the memory 112, or stored data in the database 113 may be updated through the external interface 114 using externally furnished data.

The firmware writing apparatus 100 is furnished with a near field communication portion 121 connected with the antenna 122 to make up a wireless communication capability. The near field communication portion 121 uses the same communication method as that of the near field communication portion 41 on the side of the terminal apparatus 10. The communication method adopted by this embodiment is the TransferJet method.

The firmware writing apparatus 100 is also provided with a wireless power transmission portion 130. The wireless power transmission portion 130 operating on the principle of magnetic field induction sends power in noncontact fashion to the wireless power reception portion 50 of the terminal apparatus 10.

The wireless power transmission portion 130 includes a power transmission processing portion 131 that performs processes such as a start and an end of power transmission under instructions from the control portion 111. An oscillation circuit 132 is connected to the power transmission processing portion 131. Fed with power from a power supply circuit 141, the oscillation circuit 132 generates a radio frequency signal for power transmission purposes. A power amplifier 133 amplifies the radio frequency signal output from the oscillation circuit 132. The power supply circuit 141 operates typically from commercial AC power supplied from a power supply input terminal 142.

The coil antenna 134 is connected to the power amplifier 133. A capacitor 135 is also connected to the power amplifier 133 in parallel with the coil antenna 134.

The power amplifier 133 is designed to be adjustable in its amplifying status so as to feed power simultaneously to a plurality of terminal apparatuses.

When power is to be transmitted from the wireless power transmission portion 130, the output of the oscillation circuit 132 is first amplified by the power amplifier 133. The amplified oscillation circuit output is sent to the coil antenna 134 for output. A resonant frequency f1 for use upon power transmission by the wireless power transmission portion 130 is set in correspondence with a resonant frequency f2 of the power reception portion of the terminal apparatus that receives power. The settings of the resonant frequencies will be discussed later. For example, the power amplifier 133 may perform its power amplification in a manner providing a relatively large amount of power that can simultaneously supply a plurality of terminal apparatuses 10 with power.

### 4. Explanation of Wireless Power Supply and Wireless Communication Applied to an Embodiment of the Invention

Explained below in reference to FIGS. 5A, 5B and 6 is how the wireless power transmission portion 130 of the firmware writing apparatus 100 typically transmits power in noncontact fashion to the wireless power reception portion 50 of the terminal apparatus 10. Also explained below is the state of wireless communication between the near field communication portion 121 of the firmware writing apparatus 100 and the near field communication portion 41 of the terminal apparatus 10.

This embodiment employs the magnetic resonance method for wireless power supply processing. Noncontact power transmission is accomplished with high efficiency between relatively distant apparatuses when the resonant frequency f1 on the power transmitting side and the resonant frequency f2 on the power receiving side are appropriately established.

FIG. 5A shows typical antenna structures on the power transmitting and the power receiving sides. On the power transmitting side, the resonant frequency f1 is determined by the coil antenna 134 and the capacitor 135. The characteristics of the coil antenna 134 and capacitor 135 determine a Q value representative of the sharpness of a resonance peak between these components. On the power receiving side, the resonant frequency f2 is determined likewise by the coil antenna 51 and the capacitor 52. The characteristics of the coil antenna 51 and capacitor 52 also determine a Q value representative of the sharpness of a resonance peak between these components.

In noncontact power supply based on the magnetic resonance method, a coupling coefficient K drops as the distance increases between the coils 134 and 51 on the power transmitting and the power receiving sides. In the case of this embodiment, the drop in the coupling coefficient K is compensated by the Q value of a coil so as to increase the distance over which power is wirelessly transmitted. That is, since the efficiency of power transmission is dependent on the product of the coupling coefficient K and of the Q value, the Q value may be raised through capacitor adjustments in order to increase the distance for power transmission to a certain extent.

For these reasons, the firmware writing apparatus 100 of this embodiment has the Q value of its coil antenna 134 set high.

As shown illustratively in FIG. 5B, the resonant frequency f1 of the power transmitting side and the resonant frequency f2 of the power receiving side are made somewhat different from one another. This arrangement provides the functionality of a band-pass filter that lets the frequencies between the two frequencies f1 and f2 pass through. For example, if the resonant frequency f1 of the power transmitting side is set to about 110 kHz and the resonant frequency f2 of the power receiving side is set to about 130 kHz, it is possible to implement efficient wireless power transmission involving a passband being set up between the two frequencies shown in FIG. 5B. In this manner, the efficiency of power supply is raised by setting the resonant frequency of the antenna on the power transmitting side to a frequency shifted somewhat from the resonant frequency of the antenna on the power receiving side.

During wireless power transmission by the magnetic resonance method, the efficiency of transmission remains virtually stable regardless of the angle formed by the coil antennas of the power transmitting and the power receiving sides. For example, in FIG. 6, a characteristic x0 represents the insertion loss in effect when the angle between the power transmitting and the power receiving coils is zero; a characteristic x45 denotes the insertion less in effect when the angle between the two coils is 45 degrees; and a characteristic x90 stands for the insertion loss in effect when the angle between the two coils is 90 degrees. As can be seen in FIG. 6, the efficiency of transmission remains practically unchanged regardless of the relative angle formed between the coils. Thus when power is to be transmitted from the firmware writing apparatus 100 to the terminal apparatuses 10 in the boxes 300 as shown in FIG. 1 for example, the transmission characteristics remain unchanged regardless of the direction in which the terminal apparatuses 10 are packaged.

By resorting to the same principle, it is possible to increase the distance of wireless communication between the near field communication portion 121 of the firmware writing apparatus 100 and the near field communication portion 41 of the terminal apparatus 10.

That is, the TransferJet method applied to this embodiment allows the Q value to be raised. The distance over which wireless communication can be conducted may be increased to about one meter by setting the Q value high for the antenna 122 of the firmware writing apparatus 100.

The resonant frequency f1 of the antenna 122 of the firmware writing apparatus 100 and the resonant frequency f2 of the antenna 32 of the terminal apparatus 10 are established in a manner providing the band-pass filter characteristic shown in FIG. 5B. For example, the resonant frequency f2 of the antenna 32 of the terminal apparatus 10 may be set to about 4.2 GHz and the resonant frequency f1 of the antenna 112 of the firmware writing apparatus 100 may be set to about 4.7 GHz. On the frequency band between 4.2 GHz and 4.7 GHz, a transmission band is established to permit wireless transmission. As described, the resonant frequency of the antenna on the side of the firmware writing apparatus 100 is set to a frequency shifted somewhat from the resonant frequency of the antenna on the terminal apparatus side, so that the efficiency of transmission is raised to permit wireless transmission over a relatively long distance.

### 5. Explanation of the Firmware Updating Process Performed by an Embodiment of the Invention

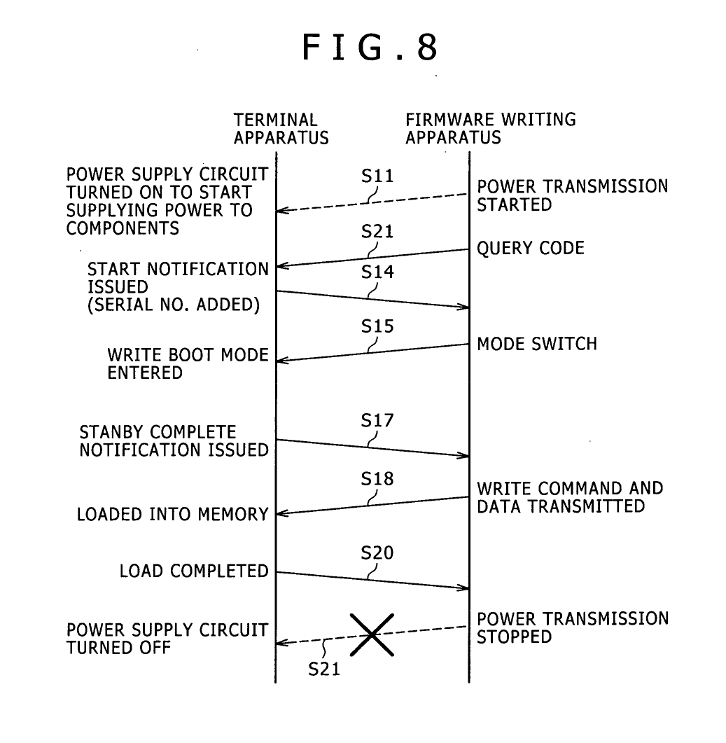

Explained below in reference to FIGS. 7A through 7D and 8 is how the firmware updating process on the terminal apparatus 10 is typically performed using the above-described firmware writing apparatus 100.

In the case of this embodiment, as shown in FIGS. 1 and 2, there are prepared a plurality of terminal apparatuses 10 with their batteries removed. The firmware of these terminal apparatuses 10 is targeted to be updated.

FIGS. 7A through 7D are schematic views explanatory of how the firmware updating process is generally performed. In each of these drawings, the right-hand side shows the firmware writing apparatus 100 and the left-hand side indicates the terminal apparatus 10. Commands, data, etc., are transmitted wirelessly between the firmware writing apparatus 100 and the terminal apparatus 10 in FIGS. 7A through 7D by the near field communication portions 41 and 121.

In the firmware writing apparatus 100, the memory 112 stores the firmware data to be written to each terminal apparatus, and the database 113 retains data including those specifying the serial numbers of the terminal apparatuses to which the firmware is to be written. For example, the database 113 may keep its data in conjunction with management data such as serial numbers about the terminal apparatuses 10 manufactured in the factory.

In that state, as shown in FIG. 7A the firmware writing apparatus 100 causes the wireless power transmission portion 130 to transmit power wirelessly (in step S11). The wireless power transmission is continued until the updating of all prepared terminal apparatuses 10 is completed.

Fed with wirelessly transmitted power, the terminal apparatus 10 has its relevant components powered and allows the control portion 21 to start operating (in step S12). The activated control portion 21 starts up the near field communication portion 41 (in step S13) and causes it to transmit a start-up notification to the firmware writing apparatus 100 (in step S14). The start-up notification is issued as a response to a signal from the near field communication portion 121 of the firmware writing apparatus 100.

Thereafter, as shown in FIG. 7B, the firmware writing apparatus 100 transmits a mode switch command to the terminal apparatus 10 that has issued the start-up notification (in step S15). Upon receipt of the command, the terminal apparatus 10 under control of the control portion 21 switches its operation mode to write boot mode and starts up only the processing portions related to writing of the firmware (in step S16). The start-up in write boot mode shortens the time it takes to activate the apparatus compared with an ordinary start-up procedure.

Following the start-up in write boot mode, the terminal apparatus 10 sends a standby complete notification to the firmware writing apparatus 100 (in step S17).

Upon receipt of the standby complete notification, the firmware writing apparatus 100 reads the firmware write data from the memory 112 and wirelessly transmits the retrieved data to the terminal apparatus 10, as shown in FIG. 7C. On receiving the transmitted data, the terminal apparatus 10 performs a loading process to write the data to the memory 22 (in step S19).

Upon completing the storage of the loaded data into the memory 22, the terminal apparatus 10 transmits a load complete message to the firmware writing apparatus 100 as shown in FIG. 7D (in step S20). In this manner, the firmware is written anew to the terminal apparatus 10 for firmware update.

The flowchart in FIG. 8 is a sequence diagram detailing the steps shown in FIGS. 7A through 7D. In FIG. 8, the steps corresponding to those found in FIGS. 7A through 7D are designated by the same reference numerals.

First, the firmware writing apparatus 100 starts wireless power transmission (in step S11). The wireless power transmission is continued until the updating of all terminal apparatuses 10 positioned close to the firmware writing apparatus 100 is completed.

After starting the wireless power transmission, the firmware writing apparatus 100 sends a query command to the terminal apparatus 10 (in step S21). At this point, the terminal apparatus 10 started up by the transmitted power and having received the query command issues a start-up notification in response to the query (in step S14). The start-up notification is transmitted together with additional data such as the serial number identifying the responding terminal apparatus 10.

Upon receipt of the start-up notification, the firmware writing apparatus 100 transmits a mode switch command to the terminal apparatus 10 whose serial number has been given by the notification (in step S15), whereby the terminal apparatus 10 is started up in write boot mode.

Upon completing its start-up in write boot mode, the terminal apparatus 10 transmits a standby complete notification together with its serial number (in step S17).

Upon receipt of the standby complete notification, the firmware writing apparatus 100 sends a firmware write command as well as the firmware data to be written to the terminal apparatus 10 identified by the serial number (in step S18). The terminal apparatus 10 loads the transmitted data. Upon completion of the loading process, the terminal apparatus 10 transmits a load complete message together with the serial number (in step S20).

Upon completion of the data writing process on all terminal apparatuses 10 targeted to have their firmware updated, the firmware writing apparatus 100 stops the wireless power transmission initiated in step S11. Since the terminal apparatuses 10 are not furnished with batteries, they are switched off the moment the wireless power transmission is terminated.

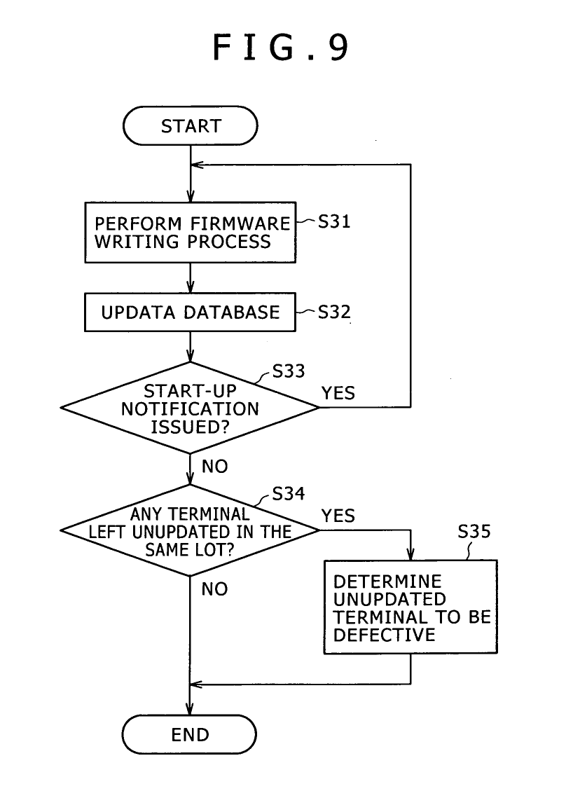

The flowchart in FIG. 9 shows a typical management process performed by the firmware writing apparatus 100 on the terminal apparatuses 10 having had their firmware written thereto.

After the firmware writing process is carried out as shown in FIGS. 7A through 7D and 8 (in step S31) and upon completion of the writing process on any one terminal apparatus, the firmware writing apparatus 100 designates in the database 113 the data of the applicable serial number as having been written (in step S32). The firmware writing apparatus 100 proceeds to determine whether there is any other terminal apparatus having transmitted a start-up notification (in step S33). If such a terminal apparatus having issued the start-up notification is found to exist, the firmware writing apparatus 100 performs the firmware writing process of step S31 on that terminal apparatus.

If it is determined in step S33 that there is no other terminal apparatus having issued the start-up notification, then the firmware writing apparatus 100 determines, based on the data in the database 113, whether there is any terminal apparatus yet to be updated among the terminal apparatuses of the same production lot having undergone the update work (in step S34). For example, the terminal apparatuses of the same production lot may refer to a plurality of terminal apparatuses housed in the sealed box 200 shown in FIG. 1 or a plurality of terminal apparatus placed on the pallet indicated in FIG. 2.

If there is found to exist any terminal apparatus yet to be updated among the terminal apparatuses of the same production lot, then the terminal apparatus of the applicable serial number is determined to be defective and excluded from the terminal apparatuses to be shipped. The terminal apparatus in question is readjusted or otherwise handled suitably (in step S35). In this manner, a plurality of terminal apparatuses are managed using their serial numbers.

It should be noted that the process shown in the sequence diagram of FIG. 8 is a process taking place between the firmware writing apparatus 100 and a single terminal apparatus 10. In practice, there are a plurality of terminal apparatuses 10 such as those shown in FIG. 1. Thus it might happen that the responses from the multiple terminal apparatuses 10 are processed in parallel. For example, the firmware writing apparatus 100 may wait for the start-up notifications together with the serial numbers to be received from all terminal apparatuses in step S14, and then transmit commands successively to the individual terminal apparatuses so that each terminal apparatus may have its firmware written thereto.

When the firmware writing process is carried out as explained above in connection with some examples, the terminal apparatuses kept in their packages may have their firmware updated automatically at any given point in time, such as upon shipment from the factory or during storage in the warehouse. A plurality of terminal apparatuses can be processed one after another in a short period of time for firmware update.

When the Q value of the antenna 122 attached to the firmware writing apparatus 100 is suitably set, the near field communication scheme that usually permits wireless communication over a distance of up to a few centimeters is recalibrated to provide wireless communication over a longer distance. These settings allow update work to be done efficiently. That is, the terminal apparatuses can be handled in units of a sizable production lot as shown in FIGS. 1 and 2, their firmware being updated consecutively in an efficient manner.

When update work is done on the terminal apparatuses that are housed in the sealed box 200 as shown in FIG. 1, a raised output of the wireless communication or of the power transmission does not interfere with external wireless systems. Also, what is contained inside the sealed box 200 is not affected by external interference so that update work on the terminal apparatuses is carried out unfailingly.

Furthermore, since the terminal apparatuses themselves are originally equipped with the wireless power reception capability and near field communication capability for recharging and data transfer purposes respectively, there is no increase whatsoever in the production cost of these terminals. In the past, plugging and unplugging wired connectors or the like to and from the terminal apparatuses for update work could inadvertently damage the apparatuses or scratch their enclosures. With the embodiments of the invention, there is no need to worry about such problems.

### 6. Variations of Embodiments

With the above-described embodiments of the invention, the emphasis of the explanation was on the process of updating firmware on the side of the terminal apparatus 10 being activated by wireless power reception. Where firmware is not to be updated, the terminal apparatus 10 may be arranged not to be started up automatically if supplied with power wirelessly.

The flowcharts in FIGS. 10, 11 and 12 show typical processes which are different from one another and in which the terminal apparatus 10 is not started automatically upon wireless power reception.

In the example of FIG. 10, the terminal apparatus 10 waits for power to be supplied wirelessly (in step S41). When supplied with power wirelessly, the terminal apparatus 10 starts itself up using the received power (in step S42). Thereafter, the steps shown in FIGS. 7A through 7D and 8 are carried out to update the firmware (in step S43). At this point, settings are made in the updated firmware that the terminal apparatus 10 will not start up automatically upon wireless power reception.

Upon completion of the wireless power reception (in step S44), the terminal apparatus 10 is switched off (in step S45).

The above process sets the terminal apparatus 10 in such a manner that it will not start up automatically thereafter even if supplied with power wirelessly as a trigger. Thus after the process of the flowchart in FIG. 10 is carried out, the terminal apparatus 10 will not start up automatically when brought close to a wireless battery charger or the like.

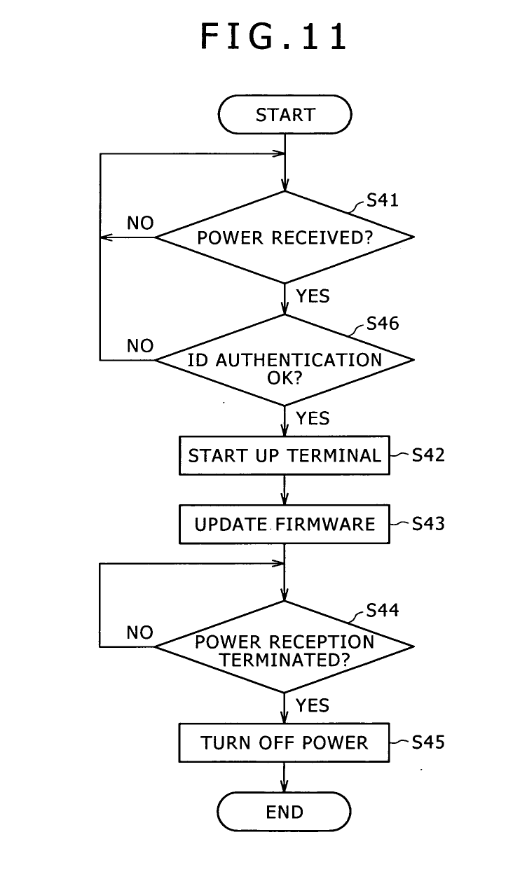

The example of FIG. 11 is one in which the process example of the flowchart in FIG. 10 is supplemented with an authentication step based on an ID code for identification purposes upon automatic start-up. In FIG. 11, the steps corresponding to those found in FIG. 10 are designated by the same reference numerals. As shown in FIG. 11, the terminal apparatus 10 waits for a wireless power transmission to be received (in step S41). When supplied with power wirelessly, the terminal apparatus 10 communicates wirelessly with the firmware writing apparatus 100 so that an authentication step is performed therebetween using an ID code for authentication (in step S46). If the authentication step is normally completed, step S42 is reached and the terminal apparatus 10 is started up. If the authentication step is not completed normally because of an ID mismatch for example, then control is returned to the start of the process. After successful completion of the authentication step, the process of FIG. 10 may be carried out for example. Alternatively, upon firmware update in step S43, the terminal apparatus 10 may not be set to guard against automatic start-up. As another alternative, upon firmware update, the ID used in step S46 for authentication may be changed instead of the terminal apparatus being set to guard against automatic start-up.

As a further alternative, the authentication in step S46 may utilize not an ID for authentication but a password or some other form of data for authentication purposes.

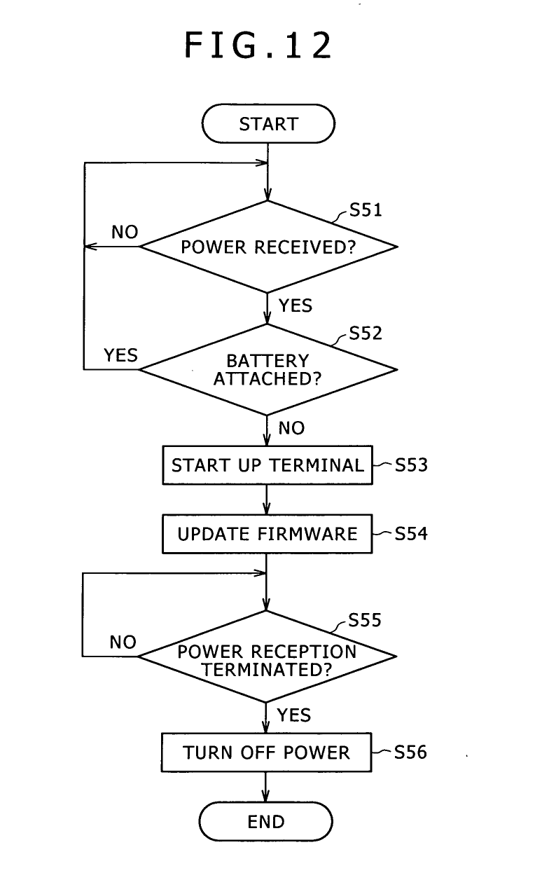

In the example of FIG. 12, the terminal apparatus 10 waits for a wireless power transmission to be received (in step S51). When the control portion inside the terminal apparatus 10 is started up upon wireless power reception, the terminal apparatus 10 determines whether the battery 62 is attached to the battery attaching portion 64 of the terminal (in step S52). The determination may be performed either by use of a switch or the like for checking if the battery 62 is attached or by checking whether a voltage equivalent to that of the battery is detected.

If the battery 62 is found not to be attached, then the terminal apparatus 10 starts itself up using the received power (in step S53). Thereafter, the steps shown in FIGS. 7A through 7D and 8 are carried out to execute the firmware updating process (in step S54).

Upon completion of the wireless power reception (in step S55), the terminal apparatus 10 is switched off (in step S56).

When the above steps have been performed and when the user, given a shipped product, attaches the battery to the product, the terminal apparatus 10 in question will not start up thereafter even if supplied with power wirelessly as a trigger. Thus after the process of the flowchart in FIG. 12 is carried out, the terminal apparatus 10 will not start up automatically when brought close to a wireless battery charger or the like. Alternatively, prior to execution of the start-up process of step S53 in the flowchart of FIG. 12, the same authentication process as that of step S46 in FIG. 11 may be performed using an ID code or the like for authentication purposes.

In the foregoing description of the embodiments of the invention, the firmware was shown written anew to the terminal apparatuses for firmware update upon shipment from the factory or during storage in the warehouse. Alternatively, the firmware updating process may be carried out at some other suitable point in time.

For example, in the flowchart of FIG. 12, the terminal apparatus 10 was shown started up automatically for firmware update when fed with power wirelessly without the battery 62 being attached to the battery attaching portion 64 of the terminal apparatus 10. Alternatively, while the battery 62 is being attached and usable by the terminal apparatus 10, the firmware updating process may still be performed automatically upon wireless power reception, with ID-based authentication carried out as well.

Also, the power for the authentication process may be supplied either wirelessly or from the attached battery 62.

Whereas the invention was shown applied to the terminal apparatus 10 that is a mobile phone terminal apparatus in the foregoing description, this is not limitative of the invention. The invention can be applied to any other terminal apparatus designed to provide other functionality as long as the terminal in question is furnished with the wireless power reception and near field communication capabilities.

The structure of the firmware writing apparatus 100 shown in FIG. 3 and elsewhere is only an example; the firmware writing apparatus 100 may be structured otherwise. For example, only the processing portions for communication and power transmission such as the antenna 122 for communication and the coil antenna 134 for power transmission may be set up on the side of the sealed box 200 shown in FIG. 1. In this setup, the apparatus proper for performing the firmware writing process may be located away from the sealed box 200. Also, the device for executing wireless power transmission and the device for transmitting firmware write data may be structured separately from each other. Also in the foregoing description, the embodiments of the invention were shown adopting the magnetic resonance method. Alternatively, some other suitable wireless power transmission scheme may be utilized.

Also in the foregoing description, the invention was shown applied to the process of having data written to the terminal apparatus such as a mobile phone terminal apparatus for firmware update. Alternatively, the invention may be applied to a testing system in which a device on the control side may first write performance check data to the terminal apparatus under test that was started up with wirelessly transmitted power. The system may then cause the terminal apparatus to return a result of the performance check, thereby testing the terminal apparatus for performance.

The present application contains subject matter related to that disclosed in Japanese Priority Patent Application JP 2010-150176 filed in the Japan Patent Office on Jun. 30, 2010, the entire contents of which is hereby incorporated by reference.

It should be understood by those skilled in the art that various modifications, combinations, sub-combinations and alterations may occur depending on design requirements and other factors in so far as they are within the scope of the appended claims or the equivalents thereof.

What is claimed is:

1. A terminal apparatus updating method comprising:
performing a wireless power supply process of wirelessly supplying power to a terminal apparatus equipped with a wireless power reception portion so as to start up said terminal apparatus thus powered;
performing a wireless transmission process of wirelessly transmitting firmware write data to said terminal apparatus started up in said wireless power supply process using a suitable wireless communication function;
performing a write process of causing said terminal apparatus having received said firmware write data in said wireless transmission process to write said firmware write data to a storage portion inside said terminal apparatus; and
stopping said wireless power supply process upon determination that said write process is completed.

2. The terminal apparatus updating method according to claim 1, wherein said wireless transmission process provides filter characteristics determined by two frequencies, one frequency being a resonant frequency of an antenna used by an entity transmitting said firmware write data, the other frequency being set to a frequency shifted from the resonant frequency of an antenna attached to said terminal apparatus.

3. The terminal apparatus updating method according to claim 2, wherein said wireless transmission process includes transmitting a query command to the terminal apparatuses and wirelessly transmitting said firmware write data to the terminal apparatuses that have responded to said query command.

4. The terminal apparatus updating method according to claim 3, wherein said query command includes a command to switch start-up mode of the terminal apparatuses to write start-up mode; and
the terminal apparatuses having received the command to switch to said write start-up mode start up solely a processing portion thereof related to the writing of firmware.

5. The terminal apparatus updating method according to claim 4, wherein said terminal apparatuses powered wirelessly in said wireless power supply process are started up when they are not provided with batteries.

6. The terminal apparatus updating method according to claim 4, wherein said terminal apparatuses are updated by the firmware written to the storage portions thereof in said write process in such a manner that once said wireless power supply process is stopped, said terminal apparatuses are not started up when wirelessly supplied with power.

7. A data writing apparatus comprising a control portion configured to supply power wirelessly to a terminal apparatus equipped with a wireless power reception portion so as to start up said terminal apparatus thus powered; to transmit firmware write data wirelessly to said terminal apparatus started up when wirelessly supplied with power using a suitable wireless communication function so that said firmware write data is written to said terminal apparatus; and to stop the wireless power supply following the writing of said firmware write data.

8. The data writing apparatus according to claim 7, further comprising:
a wireless power transmission portion configured to transmit power under control of said control portion;
a wireless communication portion configured to communicate wirelessly with said terminal apparatus under control of said control portion; and
a storage portion configured to store said firmware write data.

9. The data writing apparatus according to claim 8, wherein an antenna attached to said wireless power transmission portion has a resonant frequency set to a frequency shifted from the resonant frequency of a wireless communication antenna attached to said terminal apparatus, the two resonant frequencies providing filter characteristics permitting communication over a frequency band delimited by the resonant frequencies of the two antennas.

10. The data writing apparatus according to claim 9, wherein said control portion identifies the terminal apparatus that has completed the writing of said firmware write data;
said data writing apparatus further comprising a database portion configured to manage the terminal apparatuses thus identified.

11. The data writing apparatus according to claim 10, wherein, under control of said control portion, said wireless communication portion transmits a command to switch start-up mode of the terminal apparatuses to write start-up mode.

12. The data writing apparatus according to claim 11, further comprising a sealed box configured to house said terminal apparatuses;
wherein said terminal apparatuses inside said sealed box are supplied wirelessly with power from said wireless power transmission portion and communicate wirelessly with said wireless communication portion.

13. A terminal apparatus comprising a control portion configured to start up said terminal apparatus upon detecting reception of power in a wireless power reception process and, upon receiving firmware write data in the start-up state using a suitable wireless communication function, to perform a control process of writing the received firmware write data to a storage portion of said terminal apparatus.

14. The terminal apparatus according to claim 13, wherein said control portion transmits a serial number of said terminal apparatus in response to a command received using said wireless communication function and performs a control process of writing to said storage portion said firmware write data received after the serial number transmission.

15. The terminal apparatus according to claim 14, further comprising:
a wireless power reception portion configured to perform said wireless power reception process;
a wireless communication portion configured to operate said wireless communication function; and
a storage portion configured to store said firmware write data received by said wireless communication portion.

16. The terminal apparatus according to claim 15, further comprising a battery housing portion;
wherein, with no battery attached to said battery housing portion, said control portion performs a control process of starting up said terminal apparatus when said wireless power reception portion receives power; and
if said terminal apparatus remains turned off with a battery attached to said battery housing portion, said control portion performs a control process of not starting up said terminal apparatus when said wireless power reception portion receives power.

17. The terminal apparatus according to claim 15, wherein, after said firmware write data is stored into said storage portion and while said terminal apparatus remains turned off, said control portion performs a control process of not starting up said terminal apparatus when said wireless power reception portion receives power.
